(19) United States
(12) Patent Application Publication
(10) Pub. No.: US 2018/0332908 A1
(43) Pub. Date: Nov. 22, 2018

(54) THREE-DIMENSIONAL WETSUIT

(71) Applicant: Brian Quaglia, Rehoboth, MA (US)

(72) Inventor: Brian Quaglia, Rehoboth, MA (US)

(21) Appl. No.: 15/853,805

(22) Filed: Dec. 24, 2017

Related U.S. Application Data
(63) Continuation-in-part of application No. 15/600,778, filed on May 21, 2017, now abandoned.

(51) Int. Cl. A41D 13/012; B63C 11/04; B32B 5/02; B32B 25/10; B32B 25/16; B32B 25/14; B32B 5/18; B32B 5/24

(52) U.S. Cl. CPC A41D 13/012; B32B 2437/00; B32B 5/02; B32B 25/10; B32B 25/16; B32B 25/14; B32B 5/18; B32B 5/245; B63C 2011/046; B32B 2255/10; B32B 2266/0207; B32B 2307/51; B32B 2307/304; B32B 2307/554; B32B 2307/7145; B32B 2307/746; B63C 11/04

(57) ABSTRACT

A WETSUIT which is a 3D WETSUIT with at least one depth component on at least one portion of the Garment or Outfit or to any component of the WETSUIT providing for a higher level of Character authenticity by the utilizing or adding of three dimensional materials either integrated or associated with or attached to and therefore significantly improving upon the role play and dress up experience of the wearer the garment or outfit incorporating texture, fabric, a greater involvement of the sense of feel so that more senses are used other than vision.

### CROSS-REFERENCE TO RELATED APPLICATIONS

This application claims the priority and benefit of U.S. provisional application No. 62/381,069, filed Aug. 30, 2016. All above mentioned applications are incorporated herein in their entirety by this reference.

This application is a continuation in part of application Ser. No. 15/600,778, filed on 2017 May 27 and claims priority to and the benefit of that application which is incorporated herein in its entirety by this reference.

### FIELD OF INVENTION

The invention is in the field of Aqua sportswear, more particularly Outfits and Garments and pieces of clothing that are made of rubber and/or neoprene and that are worn by swimmers, divers, scuba divers, when snorkeling, when surfing, and used in other sports and in particular watersports and competitions, etc., and by person(s) when they are in cold water in order to keep their bodies warm. The invention incorporates 3d components which provide for a higher level of Character authenticity by the utilizing or adding of three dimensional materials either integrated or associated with or attached to and significantly improves upon the role play and dress up experience incorporating texture, fabric, a greater involvement of the sense of feel so that more senses are used other than vision.

### SUMMARY OF INVENTION

If a person enthusiastically wants to engage in an activity, the outcome is more likely to be a positive.

The present invention of A THREE-DIMENSIONAL WETSUIT is a WETSUIT that provides for a higher level of Character authenticity by the utilizing or adding of three dimensional materials either integrated or associated with or attached to. A THREE-DIMENSIONAL WETSUIT significantly improves upon the role play and dress up experience incorporating texture, fabric, a greater involvement of the sense of feel so that more senses are used other than vision.

The invention is A THREE-DIMENSIONAL WETSUIT comprising:
at least one WETSUIT component comprising in no particular order of the following;
   an athletic garment or outfit that is built from at least one of the following materials: completely or primarily (in whole or in part) of rubber, or neoprene, foamed neoprene, a stretchy synthetic rubber material, and/or is made out of several pieces of neoprene stitched together to cover the desired body parts, and/or with other material with characteristics required to be a wetsuit, a outer coating to reduce resistance and make the suit faster, having the characteristics of at least one of;
      quick drying;
      durability;
      providing for thermal insulation, abrasion resistance and buoyancy;
      flexibility, constructed using ultra-flexible material;
      being antibacterial;
      Inside wetsuit is a cloth liner that helps hold the suit together,
      that includes protection material for the wearer against rashes caused by abrasion, and/or by sunburn from extended exposure to the sun;
      has coverage and protection while partaking in watersports including but not limited to surfing, diving, canoe polo, water survival training, jungle environment survival training, scuba diving, snorkeling, freediving, wakeboarding, bodysurfing, bodyboarding, windsurfing, kitesurfing, kayaking, stand up paddle surfing, or swimming;
      includes a material for prevention of wax-based chafing from sliding on and off of the surf board, on either the torso, or the legs;
      includes material that features protection from the sun;
      waterproof or water resistant;
      gives protection against jelly fish stings;
      helps prevent irritation caused by rapid impact with surface water and waves as well;
      offers protection against cuts, mat burns, and the spread of diseases;
at least one front layer;
at least one back layer;
at least one depth component on at least one portion of the Garment or Outfit or to any component of the WETSUIT providing for a higher level of Character authenticity by the utilizing or adding of three dimensional materials either integrated or associated with or attached to and therefore significantly improving upon the role play and dress up experience of the wearer the garment or outfit incorporating texture, fabric, a greater involvement of the sense of feel so that more senses are used other than vision.

The said athletic garment or outfit ensures durability, and thus the garment or outfit is also lightweight, quick drying, and flexible; antibacterial; includes said protection material for the wearer against rashes caused by abrasion, and by sunburn from extended exposure to the sun; is for coverage in all temperatures while partaking in various sports and outdoor activities including but not limited to diving, surfing, canoe polo, water survival training, jungle environment survival training, scuba diving, snorkeling, freediving, wakeboarding, bodysurfing, bodyboarding, windsurfing, kitesurfing, kayaking, stand up paddle surfing, or swimming, water and beach play, pool and sun play, outdoor play, outdoor exposure; features protection from the sun, protection against jelly fish stings; helps prevent irritation caused by rapid impact with surface water and waves as well; offers protection against cuts, mat burns, and the spread of diseases can be the same material.

The three-dimensional swim WETSUIT can be used for dress-up and role-play or for leisure swim, watersport, and water-play.

The WETSUIT family of garments include one piece, full body, more than one piece outfits, garments, vests, shirts, Suits, life jackets, tops, bottoms, accessory items, and other devises.

The invention may include reliable sun protection that is officially tested for UV protection. The invention may have sun and rash protection are all-day sun and rash protection.

The three-dimensional WETSUIT may further be comprised of accessories, gloves, webbed gloves, at least one hat, footwear, goggles, masks, a snorkel, attachable appendages, permanently attached appendages, tentacles, body parts, at least one noise making device.

The three-dimensional WETSUIT may be further comprised of at least one auxiliary waterproof or water resistant container and or designated volume of space to house electronics and/or other objects.

The three-dimensional WETSUIT may have electronics that may be at least one of a sound module producing speech and/or music and/or sound effects, a lighting system producing at least one pattern of lights, a radio receiver, a walkie-talkie and/or at least two way communication system, a smart device and/or smart phone, and/or wireless communication.

The three-dimensional WETSUIT can further be styled as at least one of a character, cartoon character, a mermaid, a superhero, an animal, a princess, a fairy, an elf, a goblin, a witch, a wizard, eveningwear.

The invention may have that the garment or outfit is also quick drying, and flexible.

The invention may additionally including at least one of the following materials in whole or in part: completely or primarily (in whole or in part) of rubber, or neoprene, foamed neoprene, a stretchy synthetic rubber material, and/or is made out of several pieces of neoprene stitched together to cover the desired body parts, and/or with other material with characteristics required to be a wetsuit, Inside wetsuit is a cloth liner that helps hold the suit together, an outer coating to reduce resistance and make the suit faster, spandex, nylon, polyester, and/or lycra, in part or in whole.

The invention can be a swim training three-dimensional swim Wetsuit.

Although preferred embodiments of the present invention have been described herein it will be understood by those skilled in the art that the present invention should not be limited to the described preferred embodiments. Rather, various changes and modifications can be made within the spirit and scope of the present invention.

All of the material in this patent document issue subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### Definitions

Outfit: is a set of clothing that goes well together.
Character Branded Outfit: is an Outfit that has in at least one location an image or motif of a Character.
Garment: is an item of clothing.
Character branded Garment: is a Garment that has in at least one location an image or motif of a Character.
Character Branded Product: is a Character's image printed or integrated on or in a product. Wetsuit: a piece of clothing that is made of rubber and that is worn by swimmers, divers, etc., when they are in cold water in order to keep their bodies warm Source: Merriam-Webster's Learner's Dictionary
Full Definition of wetsuit—a close-fitting suit made of material (as sponge rubber) that is worn (as by a skin diver) especially in cold water to retain body heat and that traps a thin layer of water against the body, especially in the sea, for long periods
   it is an athletic garment or outfit made entirely or primarily (in whole or in part) of material such as rubber or neoprene or other material with characteristics required to make a wetsuit but could include lycra, spandex, cloth, nylon or polyester, and/or other materials.

The garment is used primarily for maintain body warmth but also protects the wearer against rashes caused by abrasion, or by sunburn from extended exposure to the sun.

A WETSUIT can be used for several sports including but not limited to scuba diving, diving, underwater swimming, deep water swimming, surfing, canoe polo, water survival training, jungle environment survival training (JEST), scuba diving, snorkeling, free diving, wakeboarding, bodysurfing, body boarding, windsurfing, kite surfing, kayaking, stand up paddle surfing, or swimming.

Wetsuits also offer some protection from the sun (measured by its Ultraviolet Protection Factor) and protection against jelly fish stings.

A WETSUIT helps to prevent irritation caused by rapid impact with surface water and waves as well.

Athletes who wear wetsuits also can receive protection against cuts, mat burns, and the spread of diseases.

They are built with the high quality materials described herein, ensuring total durability while empowering the user to perform, look, and feel their best.

Many now include reliable sun protection and usually now are officially tested for UV protection. Wetsuits are durable, comfortable and have safety protection. They can have the convenience of all-day sun and rash protection.

They may also include Anti-Rash Lycra Material—which saves skin from rashes Wetsuit is sometimes also spelled as two words Wet Suit.

Printed WETSUIT: is a Two-dimensional WETSUIT with printing forming a WETSUIT and/or components of a WETSUIT.

Two-dimensional WETSUIT: a WETSUIT made from material with no particular attention to any portion of the WETSUIT that touches human skin being thicker than one or more layers of material.

A Two-dimensional WETSUIT may have attached objects that add to the thickness of the material, but there is no particular design imperative to encase a volume of space to either enhance the three-dimensional appearance of the wearer or to create a low-density volume that can provide buoyancy as well as three-dimensionally enhancing the authenticity of the WETSUIT as with a three-dimensional WETSUIT.

Two Dimensional Printed WETSUIT: at least one Outfit or Garment transformed to a two dimensional Character WETSUIT by the printing forming the image or images necessary to create a level of authenticity together forming the WETSUIT and/or components of the WET SUIT.

Character: is a known or unknown animated image, a cartoon or comic image, a living or deceased celebrity, a superhero, a monster, an alien, a fictional being, a real or imaginary animal, person, place, or thing.

Printing: in the context of this invention is printing on material or fabric, embossing, silk-screening or other method of applying an image on material or fabric used in a Garment, Outfit, or WET SUIT.

Three-dimensional WETSUIT: everything a Two-dimensional WETSUIT is with the addition of at least one depth component to at least one portion of the Garment and/or Outfit and/or WETSUIT and/or components of the WETSUIT. A Three-dimensional WETSUIT is a WETSUIT that provides for a higher level of Character authenticity by the utilizing or adding of three dimensional materials either integrated or associated with or attached to. A three-dimensional WETSUIT significantly improves upon the role play and dress up experience incorporating texture, fabric, a greater involvement of the sense of feel so that more senses are used other than vision.

### 3D Wetsuit:

Are WETSUITS you wear to make yourself look like something or someone and/or if you're dressing up to affect a personality or you are playing a role. A 3D WETSUIT can also be a reproduction of a Character incorporating a level of authenticity either within or upon a Garment or Outfit or a Garment or Outfit with at least one accessory. A 3D WETSUIT can have variable levels of authenticity depending on context and usage.

Three-dimensional WETSUIT: Is a Three-dimensional WETSUIT designed to include swimming, water, beach, sun, outdoor, sport, and water play use which may incorporate fabric and materials that are in whole or in part waterproof or water resistant, Three-dimensional WETSUIT is also sometimes called a Three-dimensional Swimming WETSUIT.

The WETSUIT family of garments include one piece, full body, more than one piece outfits, garments, vests, shirts, Suits, life jackets, tops, bottoms, accessory items, and may include other devises or accessories.

Three-dimensional Swim WETSUIT and System: Is a Three-dimensional WETSUIT and System designed to include swimming, water, and water play use which may incorporate fabric and materials that are in whole or in part waterproof or water resistant.

As used herein, the term “and/or,” when used in a list of two or more items, means that any one of the listed items can be employed by itself, or any combination of two or more of the listed items can be employed. For example, if a device is described as containing components A, B, and/or C, the composition can contain A alone; B alone; C alone; A and B in combination; A and C in combination; B and C in combination; or A, B, and C in combination.

### BRIEF DESCRIPTION OF DRAWINGS

FIG. 1 depicts the front of a 1 piece neoprene surf suit with a zipper on front in the form of a 3-D dragon character;

FIG. 2 depicts the back of FIG. 1;

FIG. 3 depicts the front of a 1 piece neoprene surf suit with a zipper on front in the form of a 3-D shark character;

FIG. 4 depicts the back of FIG. 3.

### DETAILED DESCRIPTION OF THE DRAWINGS

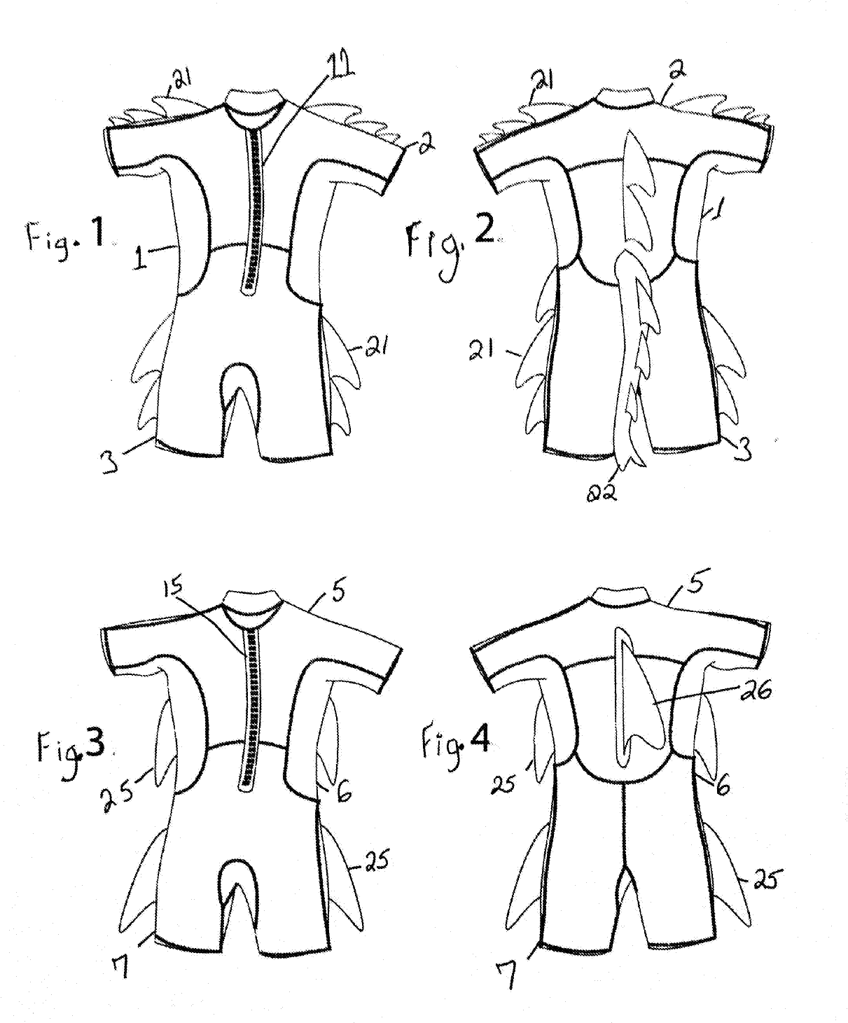

Wetsuit 1 in FIGS. 1 and 2 is shown with optional zipper 11 on the front (in front view FIG. 1) for ease of taking the wetsuit on and off. The wetsuit 1 in FIGS. 1 and 2 is an example of a three-dimensional dragon character created by the three-dimensional wetsuit of the invention. It is made of neoprene and has dragon scales 21 on the arms 2 and legs 3 of the wetsuit 1. It also has a dragon tail 22 on the back of the wetsuit shown in the view in FIG. 2.

Wetsuit 5 in FIGS. 3 and 4 is shown with optional zipper 15 on the front (in front view FIG. 3) for ease of taking the wetsuit on and off. The wetsuit 5 in FIGS. 3 and 4 is an example of a three-dimensional shark character created by the three-dimensional wetsuit of the invention. It is made of neoprene and has shark fins 25 on the sides of the torso 6 and legs 7 of the wetsuit 5. It also has a dorsal fin 26 on the back of the wetsuit shown in the view in FIG. 4.

1. A THREE-DIMENSIONAL WETSUIT comprising:
at least one WETSUIT component comprising in no particular order of the following;
an athletic garment or outfit that is built from at least one of the following materials: completely or primarily (in whole or in part) of rubber, or neoprene, foamed neoprene, a stretchy synthetic rubber material, and/or is made out of several pieces of neoprene stitched together to cover the desired body parts, and/or with other material with characteristics required to be a wetsuit, a outer coating to reduce resistance and make the suit faster, having the characteristics of at least one of;
quick drying;
durability;
providing for thermal insulation, abrasion resistance and buoyancy;
flexibility, constructed using ultra-flexible material;
being antibacterial;
Inside wetsuit is a cloth liner that helps hold the suit together,
that includes protection material for the wearer against rashes caused by abrasion, and/or by sunburn from extended exposure to the sun;
has coverage and protection while partaking in watersports including but not limited to surfing, diving, canoe polo, water survival training, jungle environment survival training, scuba diving, snorkeling, freediving, wakeboarding, bodysurfing, bodyboarding, windsurfing, kitesurfing, kayaking, stand up paddle surfing, or swimming;
includes a material for prevention of wax-based chafing from sliding on and off of the surf board, on either the torso, or the legs;
includes material that features protection from the sun;
waterproof or water resistant;
gives protection against jelly fish stings;
helps prevent irritation caused by rapid impact with surface water and waves as well;
offers protection against cuts, mat burns, and the spread of diseases;
at least one front layer;
at least one back layer;
at least one depth component on at least one portion of the Garment or Outfit or to any component of the WETSUIT providing for a higher level of Character authenticity by the utilizing or adding of three dimensional materials either integrated or associated with or attached to and therefore significantly improving upon the role play and dress up experience of the wearer the garment or outfit incorporating texture, fabric, a greater involvement of the sense of feel so that more senses are used other than vision.

2. The invention of claim 1 whereby the said athletic garment or outfit ensures durability, and thus the garment or outfit is also lightweight, quick drying, and flexible; antibacterial; includes said protection material for the wearer against rashes caused by abrasion, and by sunburn from extended exposure to the sun; is for coverage in all temperatures while partaking in various sports and outdoor activities including but not limited to diving, surfing, canoe polo, water survival training, jungle environment survival training, scuba diving, snorkeling, freediving, wakeboarding, bodysurfing, bodyboarding, windsurfing, kitesurfing, kayaking, stand up paddle surfing, or swimming, water and beach play, pool and sun play, outdoor play, outdoor exposure; features protection from the sun, protection against jelly fish stings; helps prevent irritation caused by rapid impact with surface water and waves as well; offers protection against cuts, mat burns, and the spread of diseases can be the same material.

3. The three-dimensional swim WETSUIT and system of claim 1 wherein said invention is used for dress-up and role-play or for leisure swim, watersport, and water-play.

4. The WETSUIT family of garments include one piece, full body, more than one piece outfits, garments, vests, shirts, Suits, life jackets, tops, bottoms, accessory items, and other devises.

5. The invention of claim 1 includes reliable sun protection that is officially tested for UV protection.

6. The invention of claim 1 wherein the said sun and rash protection are all-day sun and rash protection.

7. The three-dimensional WETSUIT claim 1 further comprising of accessories, gloves, webbed gloves, at least one hat, footwear, goggles, masks, a snorkel, attachable appendages, permanently attached appendages, tentacles, body parts, at least one noise making device.

8. The three-dimensional WETSUIT claim 1 further comprising of at least one auxiliary waterproof or water resistant container and or designated volume of space to house electronics and/or other objects.

9. The three-dimensional WETSUIT of claim 1 wherein said electronics is at least one of a sound module producing speech and/or music and/or sound effects, a lighting system producing at least one pattern of lights, a radio receiver, a walkie-talkie and/or at least two way communication system, a smart device and/or smart phone, wireless communication.

10. The three-dimensional WETSUIT of claim 1 is further styled as at least one of a character, cartoon character, a mermaid, a superhero, an animal, a princess, a fairy, an elf, a goblin, a witch, a wizard, eveningwear.

11. The invention of claim one whereby the garment or outfit is also quick drying, and flexible.

12. The invention of claim 1 additionally including at least one of the following materials in whole or in part: completely or primarily (in whole or in part) of rubber, or neoprene, foamed neoprene, a stretchy synthetic rubber material, and/or is made out of several pieces of neoprene stitched together to cover the desired body parts, and/or with other material with characteristics required to be a wetsuit, Inside wetsuit is a cloth liner that helps hold the suit together, a outer coating to reduce resistance and make the suit faster, spandex, nylon, polyester, and/or lycra, in part or in whole.
